(19) United States
(12) Patent Application Publication
(10) Pub. No.: US 2010/0313069 A1
(43) Pub. Date: Dec. 9, 2010

(54) COMPUTER SYSTEM AND FAILURE RECOVERY METHOD

(75) Inventor: Ippei Murata, Yokohama (JP)

Correspondence Address: FOLEY AND LARDNER LLP;SUITE 500, 3000 K STREET NW, WASHINGTON, DC, 20007, US

(73) Assignee: HITACHI, LTD.

(21) Appl. No.: 12/566,251

(22) Filed: Sep. 24, 2009

(30) Foreign Application Priority Data
Jun. 5, 2009 (JP) 2009-136068

(51) Int. Cl. G06F 11/07

(52) U.S. Cl. 714/15; 714/E11.023

(57) ABSTRACT

A computer system, comprising: a server machine; a storage system, which is coupled to the server machine; and a management computer for managing the server machine and the storage system, wherein the server machine has at least one or more programs running therein, wherein the logical storage area provided by storage system stores information about the at least one program, and wherein the computer system further includes: an access recording module for recording storage areas within the logical storage area provided by storage system storing information about the storage areas as storage area information; a boot information storing module for storing the identified boot information; a boot processing monitoring module for monitoring the processing of booting up the programs; and a program recovering module for executing recovery of one of the programs in the server machine.

### CLAIM OF PRIORITY

The present application claims priority from Japanese patent application JP 2009-136068 filed on Jun. 5, 2009, the content of which is hereby incorporated by reference into this application.

### BACKGROUND OF THE INVENTION

This invention relates to recovery from a failure of a computer in a computer system, which has failed to boot normally or the like.

In a computer system that includes a plurality of computers and a plurality storage systems, the storage systems provide part of its disk space as storage areas utilized by the computers. The computers use the provided storage areas to execute various types of processing.

The computer system executes processing of backing up data stored in each disk, or backing up system disks in the computers, in anticipation for a failure caused by logical damage to a disk or other factors.

In the event of a failure, the computer system executes processing of recovering, by identifying a disk where the failure has occurred and restoring data that has been stored in this disk by storing a backup of the data in a new disk. Recovery from a failure is thus executed, allowing the computers to continue processing of a task application or the like in the same way as before the failure.

Data backup may be performed on a entire disk, or on a necessary file system (see, for example, pages 36 to 38 of W. Curtis Preston, “Unix Backup & Recovery” which has been published by O'Reilly & Associates, Inc. in November 1999).

### SUMMARY OF THE INVENTION

In a case of backing up a entire disk, recovery from a failure takes a long period of time because a entire disk is to be recovered. This suspends the system for a long period of time, affecting processing that the computers are executing, and also affects the system boot time.

In a case of backing up a necessary file system, on the other hand, a capacity of data to back up becomes smaller and it is expected to have an effect of making the failure recovery time accordingly shorter. However, a necessary file system backup of the prior art has the following problems.

Firstly, the need for processing of selecting which part of a file system is necessary makes the processing of backing up the necessary file system difficult. Secondly, selecting an appropriate backup target from file systems is difficult.

For the above-mentioned reasons, backing up a entire disk is usually encouraged in the prior art. Consequently, the system needs to be suspended for a long period of time during failure recovery as described above.

This invention has been made in view of the above-mentioned problems.

A representative example of this invention is as follows. That is, a computer system, comprising: a server machine; a storage system, which is coupled to the server machine; and a management computer for managing the server machine and the storage system, wherein the management computer is coupled to the server machine and to the storage system, wherein the server machine comprises: a first processor; a first memory, which is coupled to the first processor; a first network interface for coupling with the management computer; a first disk interface for coupling with the storage system; and an input/output management module for managing input to and output from hardware of the server machine, wherein the management computer comprises: a second processor; a second memory, which is coupled to the second processor; a second network interface for coupling with the server machine; and a second disk interface for coupling with the storage system, wherein the storage system comprises: at least one or more storage mediums; a disk controller for managing the at least one or more storage mediums; and a third disk interface for coupling with the at least one or more storage mediums, wherein the storage system creates at least one or more logical storage areas by using a storage area of the at least one storage medium, and provides one of the logical storage areas that has been created to the server machine, wherein the server machine has at least one or more programs running therein, for executing various types of processing, wherein the server machine comprises at least one or more program control modules for controlling the programs, wherein the logical storage area provided by storage system stores information about the at least one program, and wherein the computer system further includes: an access recording module for recording storage areas within the logical storage area provided by storage system, which are accessed in processing of booting up one of the programs, and storing information about the storage areas as storage area information; an information identifying module for identifying boot information, which is necessary for booting up one of the programs, based on the storage area information stored in the access recording module; a boot information storing module for storing the identified boot information; a boot processing monitoring module for monitoring the processing of booting up the programs; and a program recovering module for executing recovery of one of the programs in the server machine based on the boot information in a case where a failure in the processing of booting up one of the programs running on the server machine is detected.

According to the aspect of this invention, which storage areas in the logical storage areas have been accessed in the system boot processing is recorded, and hence necessary information may be identified. Further, the failure recovery time may be cut short by executing failure recovery processing that uses only the identified information in recovery from a failure.

### BRIEF DESCRIPTION OF THE DRAWINGS

The present invention can be appreciated by the description which follows in conjunction with the following figures, wherein:

FIG. 1 is a block diagram illustrating an example of a configuration of a computer system according to an embodiment of this invention;

FIG. 2 is a block diagram illustrating an example of a hardware configuration of the computer system according to the embodiment of this invention;

FIG. 3 is a block diagram illustrating an example of a configuration of a system-side server machine in the case where the computer system according to the embodiment of this invention includes a virtualization environment;

FIG. 4 is an explanatory diagram illustrating an example of a referred-to block recording area according to the embodiment of this invention;

FIG. 5 is an explanatory diagram illustrating an example of a boot information storing area according to the embodiment of this invention;

FIG. 6 is an explanatory diagram illustrating a fixed area in a logical volume and a file that is accessed in boot processing according to the embodiment of this invention;

FIG. 7 is an explanatory diagram illustrating an association relation between a block location in the logical volume and a file according to the embodiment of this invention;

FIG. 8 is a flow chart illustrating processing of the system-side server machine according to the embodiment of this invention;

FIG. 9 is a flow chart illustrating processing of a system control module according to the embodiment of this invention;

FIG. 10 is a flow chart illustrating processing of a file search module according to the embodiment of this invention;

FIG. 11 is a flow chart illustrating processing of a fixed area obtaining module according to the embodiment of this invention;

FIG. 12 is a flow chart illustrating processing of a boot information transferring module according to the embodiment of this invention;

FIG. 13 is a flow chart illustrating processing of a boot information receiving module according to the embodiment of this invention;

FIG. 14 is a flow chart illustrating processing of a referred-to block recording module according to the embodiment of this invention;

FIG. 15 is a flow chart illustrating processing of a server monitoring module according to the embodiment of this invention; and

FIG. 16 is a flow chart illustrating processing of a system recovering module according to the embodiment of this invention.

### DETAILED DESCRIPTION OF THE PREFERRED EMBODIMENT

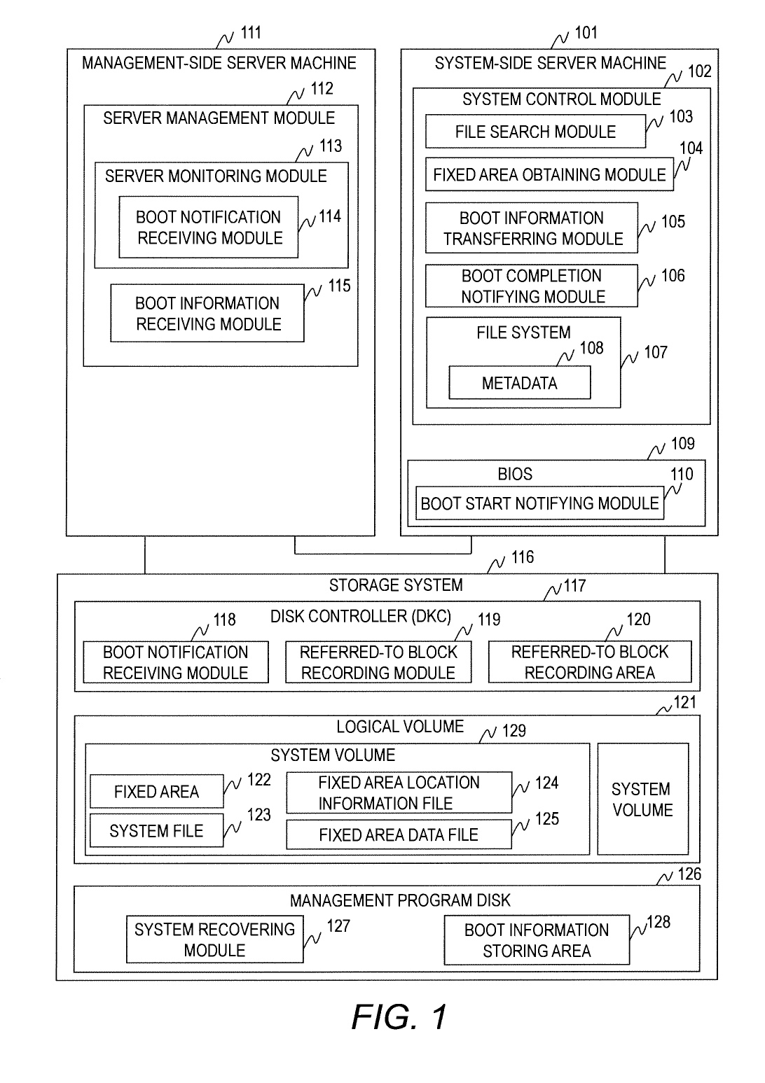

FIG. 1 is a block diagram illustrating an example of a configuration of a computer system according to an embodiment of this invention.

The computer system includes a system-side server machine 101, a management-side server machine 111, and a storage system 116. The computer system may include a plurality of the system-side server machines 101, a plurality of the management-side server machines 111, and a plurality of the storage systems 116.

In this embodiment, the system-side server machine 101 and the management-side server machine 111 are connected via a network, the system-side server machine 101 and the storage system 116 are connected directly, and the management-side server machine 111 and the storage system 116 are connected directly. Alternatively, the system-side server machine 101, the management-side server machine 111, and the storage system 116 may be connected to one another indirectly.

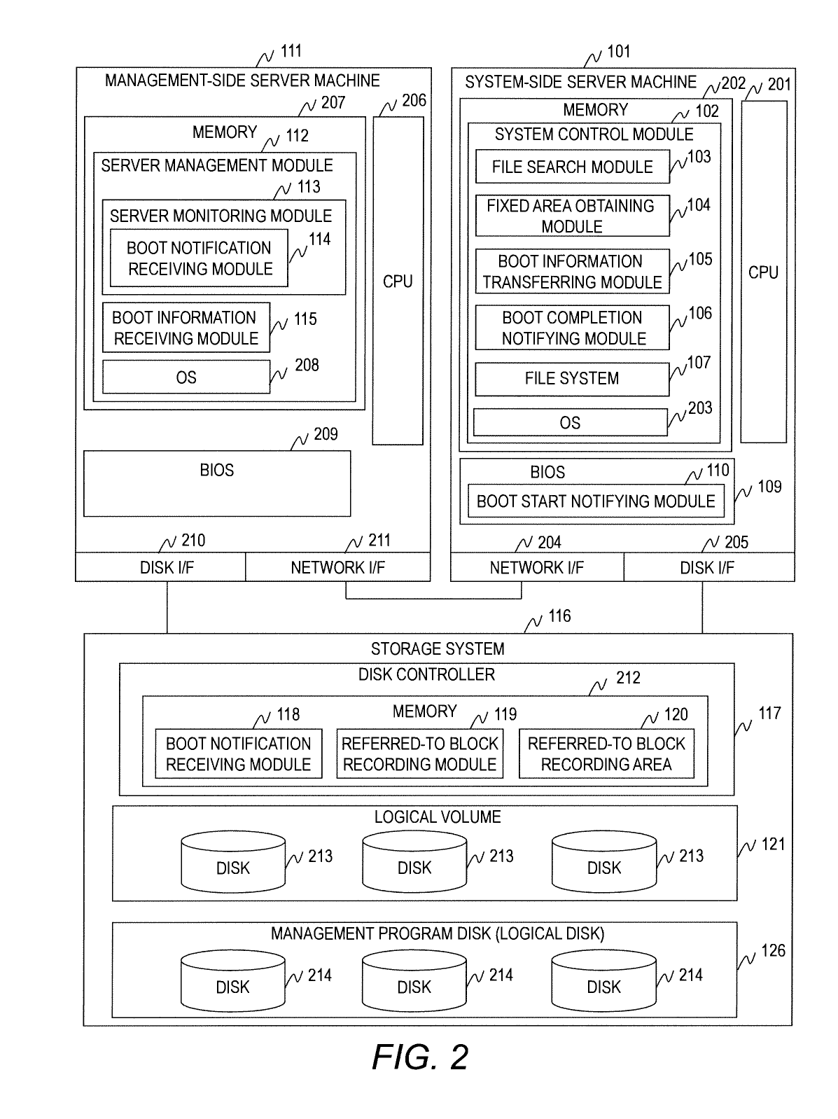

The system-side server machine 101 includes a plurality of systems, which execute various types of processing. The systems in this embodiment each include at least one OS 203 as illustrated in FIG. 2. The system-side server machine 101 includes a system control module 102 and a BIOS 109.

The system control module 102 controls system boot processing, backup processing, and the like. The system boot processing includes, at least, processing that is executed before the OS 203 illustrated in FIG. 2 is booted up and processing of booting up the OS 203 illustrated in FIG. 2. The system-side server machine 101 includes the system control module 102 for each of the plurality of systems.

The system control module 102 includes a file search module 103, a fixed area obtaining module 104, a boot information transferring module 105, a boot completion notifying module 106, and a file system 107.

The file search module 103 identifies a file from block location information. A block is the minimum unit for reading or writing data, and data is stored in a physical disk or a logical disk on a block units. The block location information is information that indicates the location of a block in a physical disk or a logical disk.

The fixed area obtaining module 104 obtains the block location of a fixed area. The fixed area is an area (group of blocks) whose blocks do not change their locations and whose data stored in the blocks is not updated while the system is in operation.

The fixed area may be, for example, a master boot record (MBR) or a boot sector. In other words, the fixed area represents data that is read before the OS 203 illustrated in FIG. 2 is booted up. The fixed area is determined, when a system is configured, based on the specifications of the system, and the system-side server machine 101 stores the determined information.

The boot information transferring module 105 sends to the management-side server machine 111 information that is necessary to execute processing of booting up one of the plurality of systems that the system-side server machine 101 includes (hereinafter referred to also as boot information). The boot completion notifying module 106 notifies the management-side server machine 111 and the storage system 116 of the completion of system boot processing.

The file system 107 manages data of a plurality of blocks as a file. The file system 107 contains metadata 108. The metadata 108 stores information about the association relation between a file and block-based data.

The BIOS 109 controls input to and output from hardware that the system-side server machine 101 includes. The BIOS 109 includes a boot start notifying module 110 for notifying the management-side server machine 111 and the storage system 116 of the start of system boot processing.

The first step of system boot processing in this embodiment is to read the BIOS 109. Thereafter, the BIOS 109 reads the MBR and the boot sector to boot up the OS 203 illustrated in FIG. 2. The start of the system boot processing is therefore notified by the BIOS 109, whereas the completion of the system boot processing is notified by the system control module 102.

The management-side server machine 111 manages and monitors the computer system. The management-side server machine 111 includes a server management module 112. The server management module 112 manages and monitors boot processing of the system-side server machine 101.

The server management module 112 includes a server monitoring module 113 and a boot information receiving module 115. The server monitoring module 113 monitors boot processing of the system-side server machine 101. The server monitoring module 113 includes a boot notification receiving module 114 for receiving notifications of the start and completion of system boot processing from the system-side server machine 101. The boot information receiving module 115 receives boot information sent from the system-side server machine 101.

The storage system 116 stores information of the system-side server machine 101 and information of the management-side server machine 111. The storage system 116 includes a disk controller (DKC) 117, a logical volume 121, and a management program disk 126.

The disk controller 117 manages physical disks 213 and 214 which are illustrated in FIG. 2 of the storage system 116. The disk controller 117 includes a boot notification receiving module 118, a referred-to block recording module 119, and a referred-to block recording area 120.

The boot notification receiving module 118 receives notifications of the start and completion of system boot processing from the system-side server machine 101. The referred-to block recording module 119 records the block location of a block in the logical volume 121 that has been accessed in system boot processing. The referred-to block recording area 120 stores information recorded by the referred-to block recording module 119.

The block location of a block in the logical volume 121 that has been accessed in system boot processing is hereinafter referred to also as referred-to block location.

The logical volume 121 stores data of the plurality of systems that the system-side server machine 101 includes. The storage system 116 stores one logical volume 121 for one system-side server machine 101.

The logical volume 121 is composed of a logical storage area (logical unit (LU)) created by logically partitioning storage areas of the disks 213 that the storage system 116 includes. The logical volume 121 may include a plurality of LUs. The system-side server machine 101 recognizes the logical volume 121 as one storage area (for example, as one physical disk).

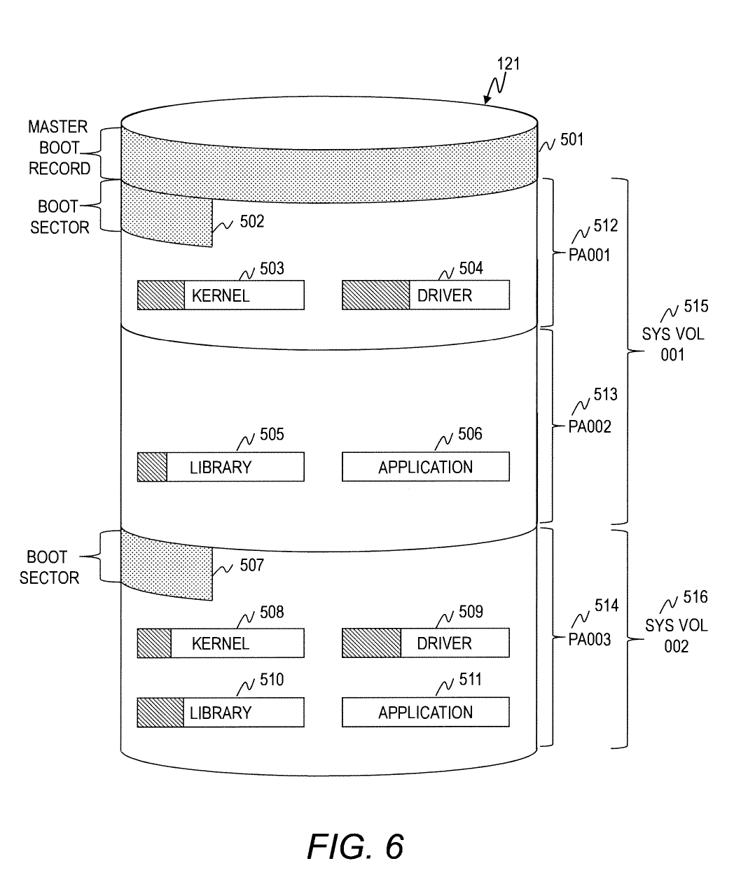

The logical volume 121 stores system volumes 129 for each systems. One system volume 129 exists in one system (OS 203 illustrated in FIG. 2). Details of the logical volume 121 are described later with reference to FIG. 6.

The system volume 129 stores a fixed area 122, a system file 123, a fixed area location information file 124, and a fixed area data file 125.

The fixed area 122 is an area whose blocks do not change their locations and whose data stored in the blocks is not updated while the system is in operation. Specifically, the fixed area 122 stores a data that is read before the OS 203 illustrated in FIG. 2 is booted up.

The system file 123 stores a file relevant to the OS 203 illustrated in FIG. 2.

The fixed area location information file 124 stores the block location of the fixed area 122. The fixed area data file 125 stores specific information of the fixed area 122. The storage system 116 thus keeps track of information about fixed areas of the plurality of systems that the system-side server machine 101 includes.

The management program disk 126 stores data of the management-side server machine 111. The management program disk 126 includes one or more LUs. The management-side server machine 111 recognizes the management program disk 126 as one storage area (for example, as one physical disk).

The management program disk 126 stores a system recovering module 127 and a boot information storing area 128.

The system recovering module 127 executes processing of recovering the system-side server machine 101. The boot information storing area 128 stores boot information. The boot information includes, at least, information about the fixed area 122 and information about a file that has been accessed in the processing of booting up the OS 203 illustrated in FIG. 2.

The storage system 116 may include the server management module 112. The system-side server machine 101 may include the logical volume 121. The management-side server machine 111 may include the management program disk 126.

FIG. 2 is a block diagram illustrating an example of a hardware configuration of the computer system according to the embodiment of this invention.

The system-side server machine 101 includes a CPU 201, a memory 202, a network I/F 204, and a disk I/F 205.

The CPU 201 executes a program loaded on the memory 202. The memory 202 stores the system control module 102. The network I/F 204 is an interface for connecting with the management-side server machine 111 via a network. The disk I/F 205 is an interface for connecting with the storage system 116.

The management-side server machine 111 includes a CPU 206, a memory 207, a disk I/F 210, and a network I/F 211.

The CPU 206 executes a program loaded on the memory 207. The memory 207 stores the server management module 112. The network I/F 211 is an interface for connecting with the system-side server machine 101 via a network. The disk I/F 210 is an interface for connecting with the storage system 116.

The storage system 116 includes the plurality of physical disks (213 and 214) connected to the disk controller 117. In this embodiment, LUs are created on the storage area of one or more physical disks (213 and 214). The logical volume 121 is created from one or more LUs. The logical volume 121 stores data of each of the plurality of systems. One or more physical disks (213 and 214) in the storage system 116 may constitute a RAID.

The storage system 116 may include storage media other than the physical disks (213 and 214) (for example, solid-state drive (SSD)).

The computer system may include a virtualization environment. How the system-side server machine 101 is configured when the computer system includes a virtualization environment is described below.

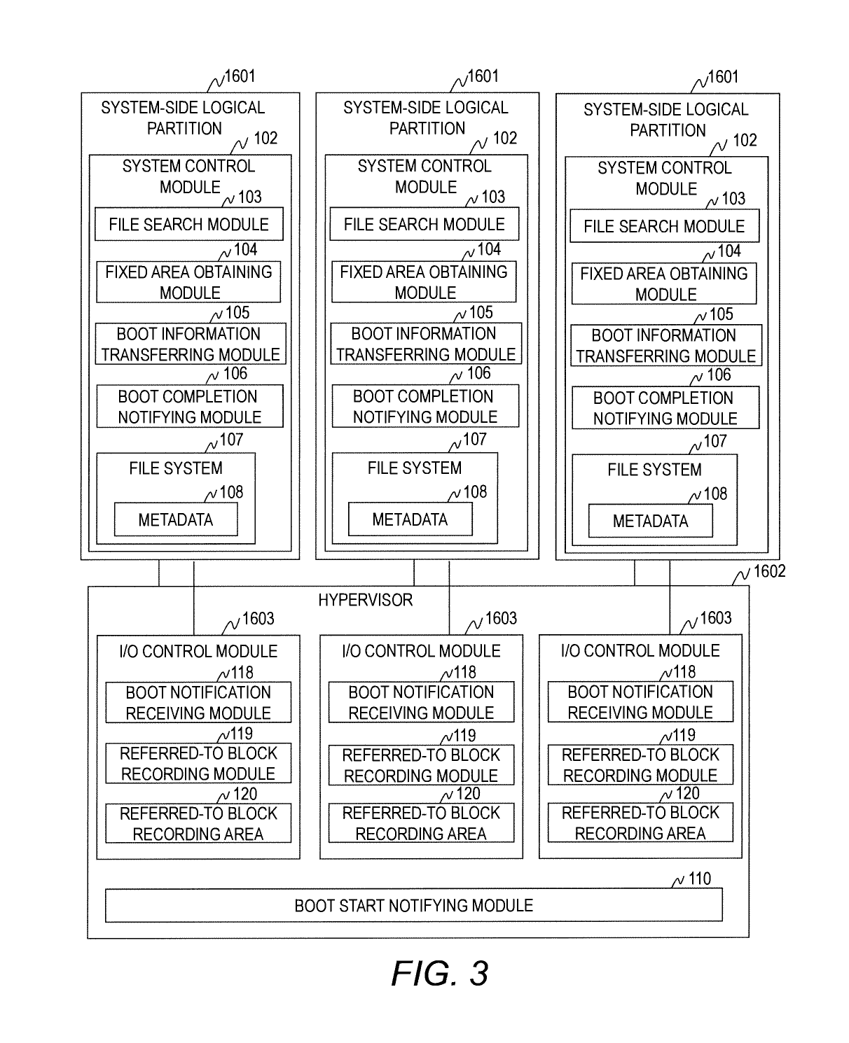

FIG. 3 is a block diagram illustrating an example of a configuration of the system-side server machine 101 in the case where the computer system according to the embodiment of this invention includes a virtualization environment.

A hardware configuration of the system-side server machine 101 in this case is the same as in FIG. 2, and its description is therefore omitted here.

In the system-side server machine 101, the OS 203 is run on each of a plurality of system-side logical partitions 1601, which are created by logically partitioning hardware resources (CPU 201, memory 202, network I/F 204, and disk I/F 205).

The system-side logical partitions 1601 are managed by a hypervisor 1602 that the system-side server machine 101 includes. The system-side server machine 101 may not include the BIOS 109.

The hypervisor 1602 includes I/O control modules 1603 for controlling the system-side logical partitions 1601, and the boot start notifying module 110 for notifying the boot start of the system-side logical partitions 1601.

The I/O control modules 1603 each include the boot notification receiving module 118, the referred-to block recording module 119, and the referred-to block recording area 120. In short, in a virtualization environment, the hypervisor 1602 includes the same functions as those of the disk controller 117.

To access the storage system 116, the hypervisor 1602 receives an access request from one of the system-side logical partitions 1601 via the I/O control module 1603, and sends an access request based on the received access request to the disk controller 117 of the storage system 116.

The disk controller 117 reads necessary data from the logical volume 121 allocated to the system-side server machine 101, and sends the read data to the system-side server machine 101. This data includes block location information.

The hypervisor 1602 receives the data from the storage system 116 and sends the received data via the I/O control module 1603 to the one of the system-side logical partitions 1601 that has made the access request. The referred-to block recording module 119 stores the block location information included in the received data in the referred-to block recording area 120.

In a virtualization environment, the hypervisor 1602 can identify files that are needed by the system-side logical partitions 1601 through cooperation with the disk controller 117.

In the following description, components that have the same names or the same reference symbols as in FIG. 3 execute the same processing in a virtualization environment.

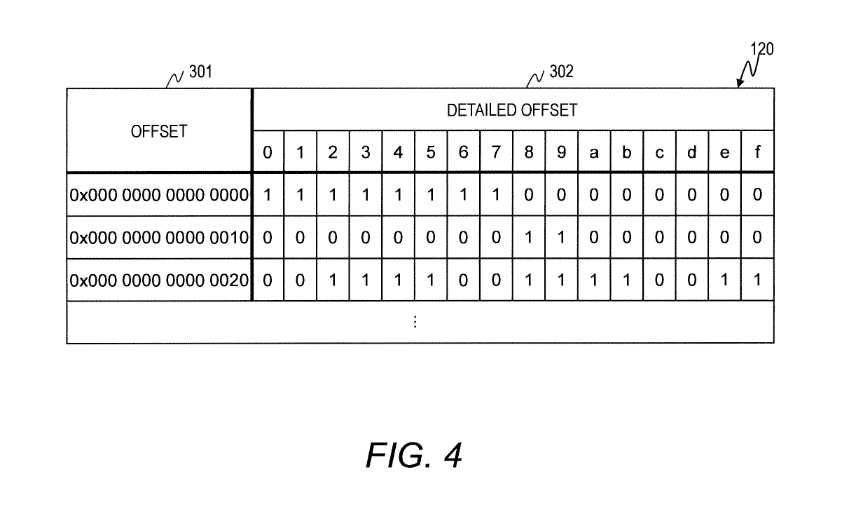

FIG. 4 is an explanatory diagram illustrating an example of the referred-to block recording area 120 according to the embodiment of this invention.

The referred-to block recording area 120 stores the block location of a block in the logical volume 121 that has been accessed in system boot processing. The referred-to block recording area 120 includes an offset 301 and a detailed offset 302.

The offset 301 indicates a block location in the logical volume 121. The offset 301 is recorded at given intervals. The detailed offset 302 indicates a block location in the logical volume 121 where access has actually been made. Specifically, “1” is stored for an accessed block location and “0” is stored for a block location where access has not been made.

In a case of the computer system has a virtualization environment, the referred-to block recording area 120 of each I/O control module 1603 stores block locations related to each the system-side logical partitions 1601.

In the example of FIG. 4, the second entry shows that “0x0000 0000 0000 0018” and “0x0000 0000 0000 0019” are block locations where access has been made in the system boot processing.

The referred-to block recording area 120 may store only block locations where access has been made in the system boot processing. The referred-to block recording area 120 may be designed in any way as long as it points out an accessed block location.

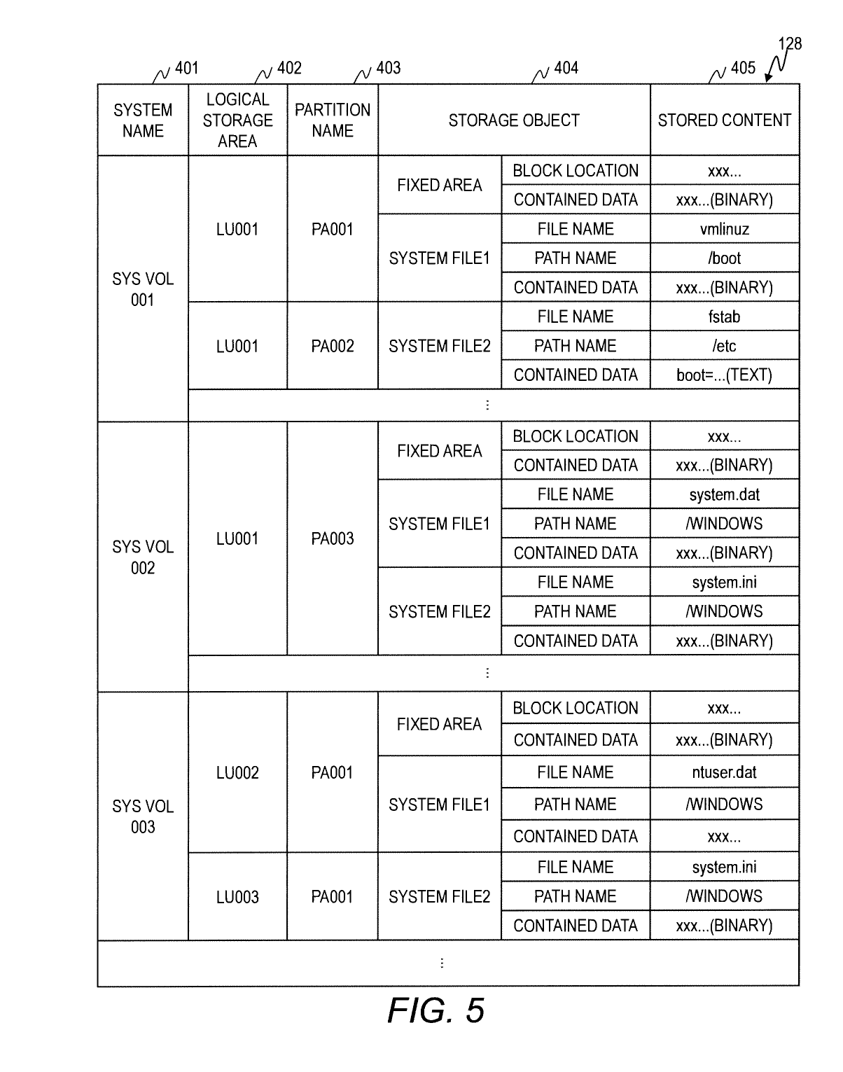

FIG. 5 is an explanatory diagram illustrating an example of the boot information storing area 128 according to the embodiment of this invention.

The boot information storing area 128 includes a system name 401, a logical storage area 402, a partition name 403, a storage object 404, and a stored content 405.

The system name 401 stores an identifier for identifying each system volume 129 on the logical volume 121. The logical storage area 402 stores an identifier for identifying which disk is used in booting up the system.

The partition name 403 stores an identifier for identifying a partition in the system volume 129.

The storage object 404 stores information about an object to be stored as boot information. Specifically, the fixed area 122 and the system file 123 are objects to be stored. In the case where the fixed area 122 is the object to be stored, the block location and included data are storage objects. In the case where the system file 123 is the object to be stored, the file name, path name, and included data of a file that has been accessed in the system boot processing are storage objects. The stored content 405 stores the specific content of the storage object 404 is stored.

In a case of the computer system has a virtualization environment, the boot information storing area 128 stores information about the respective system-side logical partitions 1601.

FIG. 6 is an explanatory diagram illustrating a fixed area in the logical volume 121 and a file that is accessed in boot processing according to the embodiment of this invention.

In this embodiment, each of the plurality of systems includes a boot sector, the OS 203, and an application, and each OS 203 includes a kernel, a driver, and a library.

The logical volume 121 includes a master boot record (MBR) 501, a system volume 515, and a system volume 516. The master boot record 501 is included in the fixed area 122.

The system volume 515 is the system volume 129 that has “SYS VOL001” as the system name 401. The system volume 516 is the system volume 129 that has “SYS VOL002” as the system name 401.

The system volume 515 includes a partition 512 and a partition 513. The partition 512 is a partition that has “PA001” as the partition name 403. The partition 513 is a partition that has “PA002” as the partition name 403.

The partition 512 includes a boot sector 502, a kernel 503, and a driver 504. The boot sector 502 is included in the fixed area 122, whereas the kernel 503 and the driver 504 are included in the system file 123. In the example of FIG. 6, hatched parts of the kernel 503 and the driver 504 indicate parts that have been accessed in the system boot processing. In other words, the hatched parts represent data accessed in the processing of booting up the OS 203.

The partition 513 includes a library 505 and an application 506. The library 505 and the application 506 are included in the system file 123. In the example of FIG. 6, a hatched part of the library 505 indicates a part that has been accessed in the system boot processing. In other words, the hatched part represents data accessed in the processing of booting up the OS 203.

The system volume 516 includes a partition 514. The partition 514 is a partition that has “PA003” as the partition name 403.

The partition 514 includes a boot sector 507, a kernel 508, a driver 509, a library 510, and an application 511. The boot sector 507 is included in the fixed area 122. The kernel 508, the driver 509, the library 510, and the application 511 are included in the system file 123.

In the example of FIG. 6, hatched parts of the kernel 508, the driver 509, and the library 510 indicate parts that have been accessed in the system boot processing. In other words, the hatched parts represent data accessed in the processing of booting up the OS 203.

Conventionally, the entire logical volume 121 has needed to be saved for recovery from a failure. In this invention, on the other hand, only information (file) that is necessary for the system boot processing may be saved as illustrated in FIG. 6. This invention also accomplishes a quicker and finer recovery from a failure by saving the information (file) necessary for system boot-up divided the necessary information into the fixed area 122 and information (file) that is included in the system file 123.

Further, in this invention, which information among the information (file) included in the system file 123 is about the hatched parts illustrated in FIG. 6 is identified, and the information about the hatched parts is saved.

In a case of the computer system has a virtualization environment, the system-side logical partitions 1601 correspond to the logical volume 121.

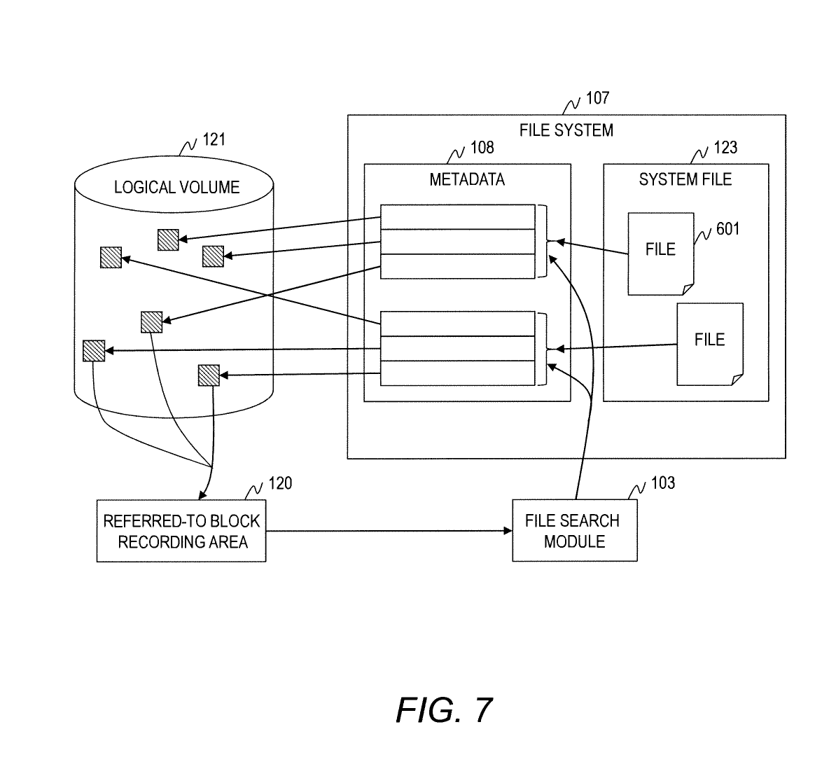

FIG. 7 is an explanatory diagram illustrating an association relation between a block location in the logical volume 121 and a file according to the embodiment of this invention.

The file system 107 stores a file 601 and the metadata 108, which indicates the association relation with a block location on the logical volume 121 where data of the file 601 is stored. The file system 107 enables the system file 123 to recognize data that is stored in a plurality of blocks on the logical volume 121 as a file 601.

The file search module 103 uses the metadata 108 stored in the file system 107 to identify the file 601.

Specifically, the file search module 103 obtains a block location on the logical volume 121 that has been stored in the referred-to block recording area 120 and, with the obtained block location as a key, searches for the metadata 108.

In a case of an index associating the obtained block location with the metadata 108 is found in the file system 107, the file search module 103 uses this index to search for the metadata. When an index associating the obtained block location with the metadata 108 is not found in the file system 107, the file search module 103 searches pieces of metadata 108 sequentially until the metadata 108 that includes the obtained block location is found.

The file search module 103 then identifies the relevant file 601 from the identified metadata 108.

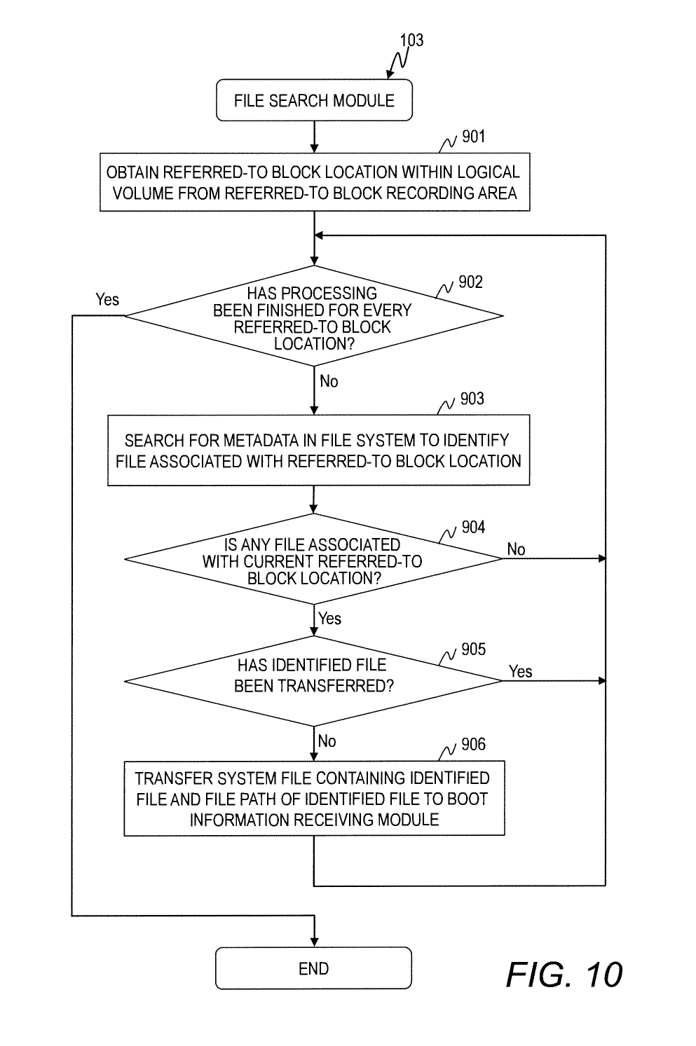

In this way, the file search module 103 may identify which file 601 is needed in the system boot processing out of the files 601 included in the system file 123. Details of the file search module 103 are described later with reference to FIG. 10.

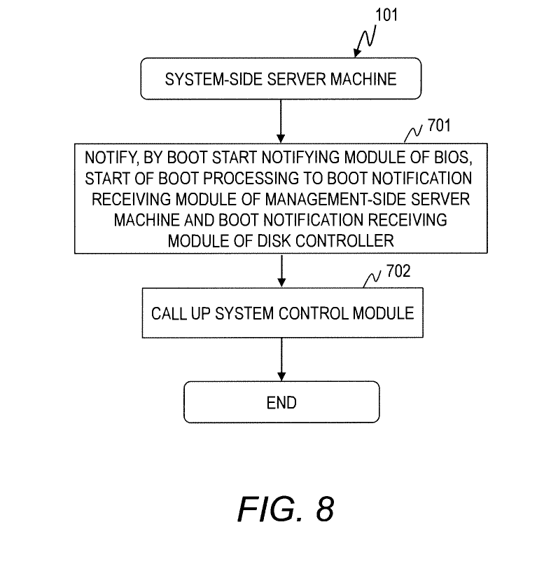

Processing executed when the system-side server machine 101 is booted up normally is described below with reference to FIGS. 8 to 14.

FIG. 8 is a flow chart illustrating processing of the system-side server machine 101 according to the embodiment of this invention.

When system boot processing is started in the system-side server machine 101, the BIOS 109 first uses the boot start notifying module 110 to notify the boot notification receiving module 114 of the management-side server machine 111 and the boot notification receiving module 118 of the disk controller 117 of the start of the system boot processing (Step 701).

Next, the BIOS 109 calls up the system control module 102 (Step 702) and ends the processing of FIG. 8.

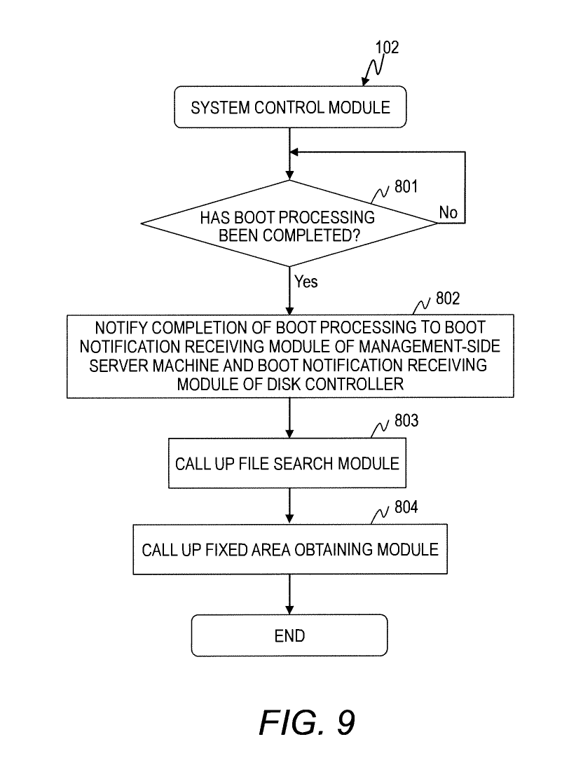

FIG. 9 is a flow chart illustrating processing of the system control module 102 according to the embodiment of this invention.

Called up by the BIOS 109, the system control module 102 determines whether or not the boot processing has been completed (Step 801). The system control module 102 periodically executes Step 801 until it is determined that the boot processing is complete.

In a case of determining that the boot processing is complete, the system control module 102 uses the boot completion notifying module 106 to notify the boot notification receiving module 114 of the management-side server machine 111 and the boot notification receiving module 118 of the disk controller 117 of the completion of the boot processing (Step 802).

The system control module 102 calls up the file search module 103 (Step 803), then calls up the fixed area obtaining module 104 (Step 804), and then ends the processing of FIG. 9.

FIG. 10 is a flow chart illustrating processing of the file search module 103 according to the embodiment of this invention.

The file search module 103 obtains a referred-to block location in the logical volume 121 from the referred-to block recording area 120 (Step 901). Specifically, the file search module 103 obtains from the referred-to block recording area 120 a table as the one illustrated in FIG. 4.

The file search module 103 determines whether or not processing has been finished for every referred-to block location (Step 902). Specifically, the file search module 103 determines whether or not processing for every entry in the obtained table similar to the table of FIG. 4 has been finished.

In a case of determining that processing has been finished for every referred-to block location, the file search module 103 ends the processing of FIG. 10.

In a case of determining that not all of the processing for the referred-to block locations have been finished, the file search module 103 uses the obtained referred-to block location as a key and searches for the metadata 108 in the file system 107 to identify a file that is associated with this referred-to block location (Step 903). Specifically, the file search module 103 selects one referred-to block location from the obtained table similar to the table of FIG. 4, and deter mines whether or not the file system 107 has the metadata 108 that includes this referred-to block location.

The file search module 103 determines whether or not there is a file associated with the referred-to block location (Step 904).

In a case of determining that no file is associated with the referred-to block location, the file search module 103 returns to Step 902 to execute the same processing again.

In a case of determining that there is a file associated with the referred-to block location, the file search module 103 determines whether or not the file associated with the referred-to block location has been transferred (Step 905). Specifically, the file search module 103 makes an inquiry to the management-side server machine 111 about whether or not the file associated with the referred-to block location has been transferred.

In a case of determining that the file associated with the referred-to block location has been transferred, the file search module 103 returns to Step 902 to execute the same processing again.

In a case of determining that the file associated with the referred-to block location has not been transferred, the file search module 103 transfers the identified file and the file path of the identified file to the boot information receiving module 115 via the boot information transferring module 105 (Step 906), and returns to Step 902 to execute the same processing again. The transferred information is stored in the boot information storing area 128 as boot information.

Through the processing described above, a file necessary for the processing of booting up the OS 203 is identified and information about the identified file is stored in the management-side server machine 111.

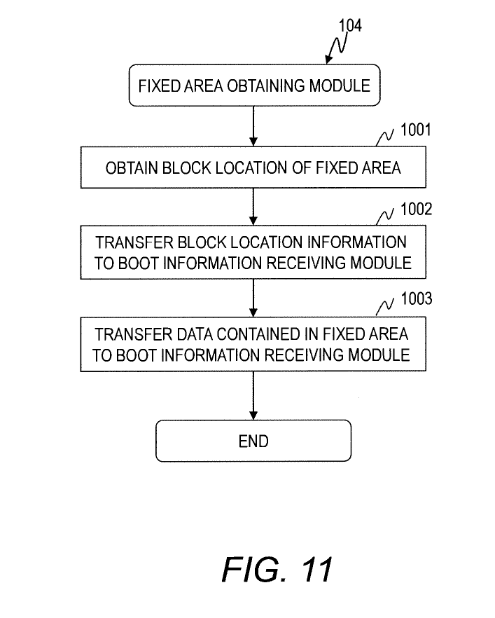

FIG. 11 is a flow chart illustrating processing of the fixed area obtaining module 104 according to the embodiment of this invention.

The fixed area obtaining module 104 obtains the block location of the fixed area 122 from the fixed area location information file 124 (Step 1001).

The fixed area obtaining module 104 transfers the block location information of the fixed area 122 to the boot information receiving module 115 via the boot information transferring module 105 (Step 1002).

The fixed area obtaining module 104 refers to the fixed area data file 125, and transfers data stored in the fixed area 122 to the boot information receiving module 115 via the boot information transferring module 105 (Step 1003). The transferred information is stored in the boot information storing area 128 as boot information.

While the system-side server machine 101 includes the fixed area obtaining module 104 in this embodiment, it may instead be the storage system 116 that includes the fixed area obtaining module 104.

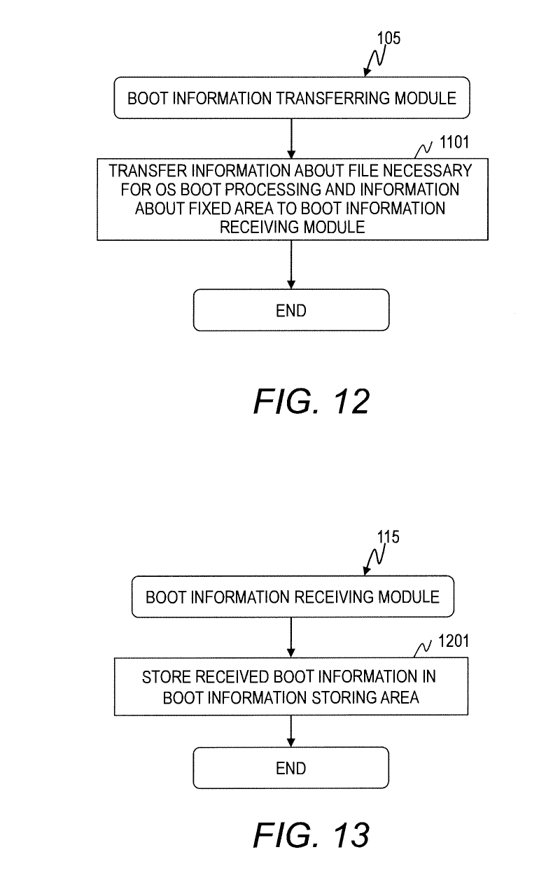

FIG. 12 is a flow chart illustrating processing of the boot information transferring module 105 according to the embodiment of this invention.

The boot information transferring module 105 transfers to the boot information receiving module 115 information sent from the file search module 103 and information sent from the fixed area obtaining module 104 (specifically, information about a file that is necessary for the processing of booting up the OS 203 and information about the fixed area 122) (Step 1101). The boot information transferring module 105 then ends the processing of FIG. 12.

FIG. 13 is a flow chart illustrating processing of the boot information receiving module 115 according to the embodiment of this invention.

The boot information receiving module 115 receives boot information sent from the boot information transferring module 105, stores the received information in the boot information storing area 128 (Step 1201), and ends the processing of FIG. 13.

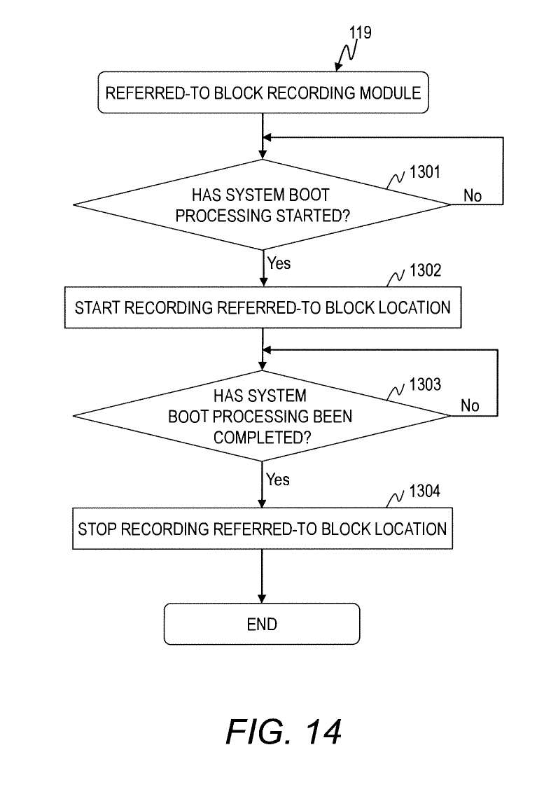

FIG. 14 is a flow chart illustrating processing of the referred-to block recording module 119 according to the embodiment of this invention.

The referred-to block recording module 119 determines whether or not system boot processing has been started (Step 1301). Specifically, the referred-to block recording module 119 makes an inquiry to the boot notification receiving module 118 about whether or not a notification of the start of system boot processing has been received from the BIOS 109.

In a case of determining that system boot processing has not been started, the referred-to block recording module 119 periodically executes Step 1301 until it is determined that system boot processing has been started.

In a case of determining that system boot processing has been started, the referred-to block recording module 119 starts recording a referred-to block location (Step 1302). In other words, the referred-to block recording module 119 starts referred-to block location recording processing with a notification of the start of system boot processing as a trigger.

The referred-to block recording module 119 determines whether or not the system boot processing has been completed (Step 1303). Specifically, the referred-to block recording module 119 makes an inquiry to the boot notification receiving module 118 about whether or not a notification of the completion of the system boot processing has been received from the boot completion notifying module 106.

In a case of determining that the system boot processing has not been completed, the referred-to block recording module 119 periodically executes Step 1303 until the system boot processing is completed.

In a case of determining that the system boot processing has been completed, the referred-to block recording module 119 ends the processing of recording a referred-to block location (Step 1304).

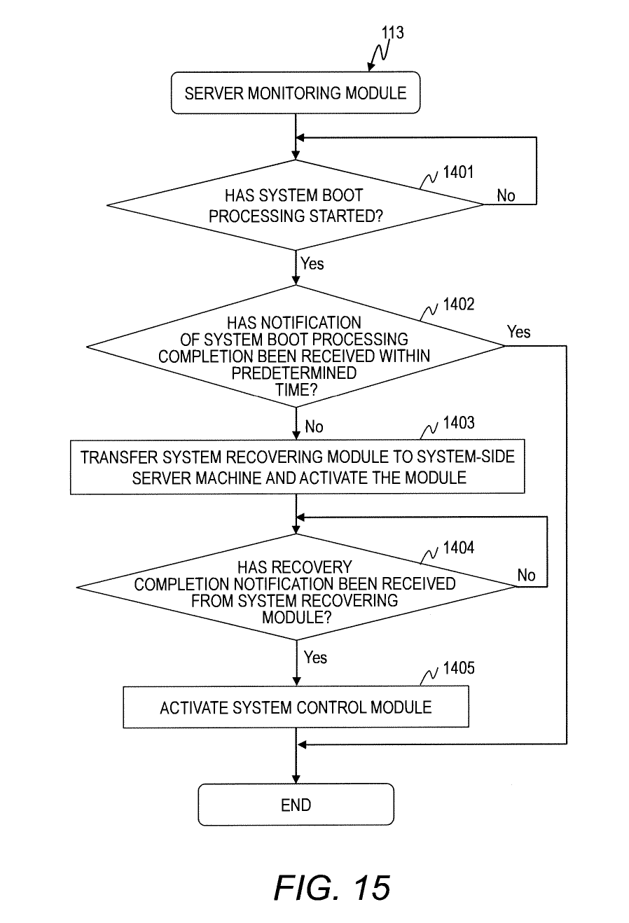

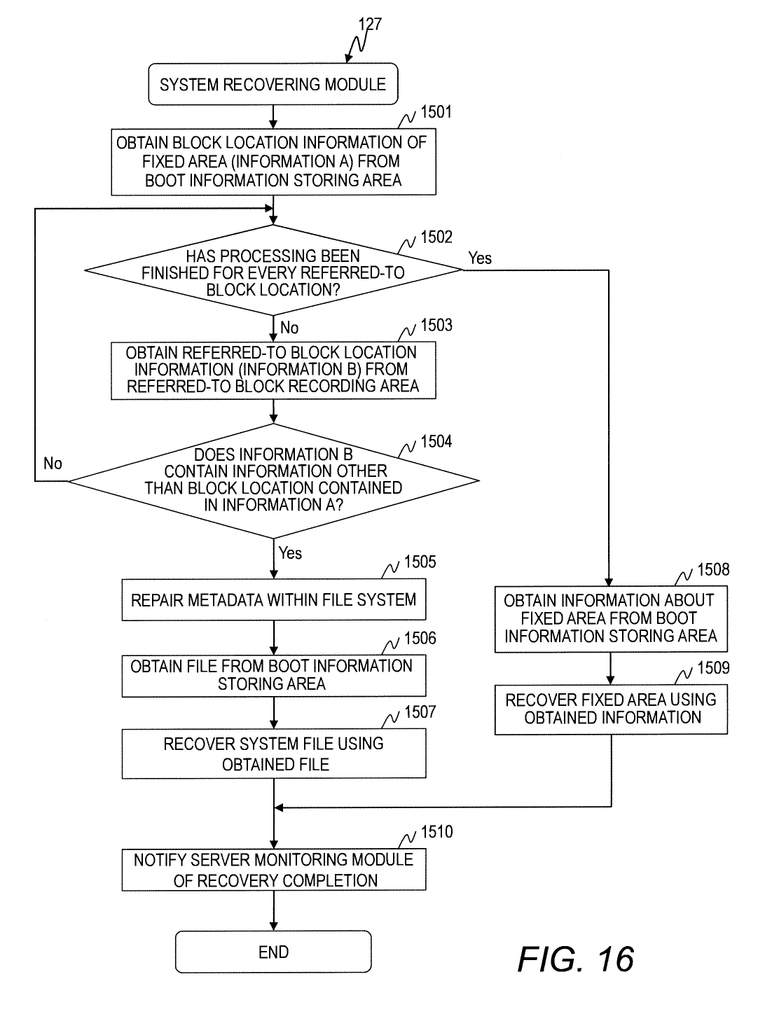

The foregoing concludes the description of the processing that is executed in a case where the system-side server machine 101 is booted up normally. Herein below, with reference to FIGS. 15 and 16, description is made of processing of monitoring for a failure of the system-side server machine 101 and recovering the system-side server machine 101 from the failure.

FIG. 15 is a flow chart illustrating processing of the server monitoring module 113 according to the embodiment of this invention.

The server monitoring module 113 determines whether or not system boot processing has been started (Step 1401). Specifically, the server monitoring module 113 makes an inquiry to the boot notification receiving module 118 about whether or not a notification of the start of system boot processing has been received from the BIOS 109. Step 1401 is processing for determining if it is time to start monitoring the system-side server machine 101.

In a case of determining that system boot processing has not been started, the server monitoring module 113 periodically executes Step 1401 until it is determined that system boot processing has been started. In a case of determining that system boot processing has been started, a timer for detecting a failure in the processing of booting up the system-side server machine 101 starts counting.

In a case of determining that system boot processing has been started, the server monitoring module 113 determines whether or not a notification of the completion of the system boot processing has been received within a given period of time (Step 1402). Specifically, the server monitoring module 113 makes an inquiry to the boot notification receiving module 114 about whether or not a notification of the completion of the system boot processing has been received from the boot completion notifying module 106.

In a case of finding in Step 1402 that a notification of the completion of the system boot processing has not been received within a given period of time, the server monitoring module 113 determines that a failure has occurred in the system boot processing. The given period of time may be a value set in advance, or a value that may be varied to suit how the system is run.

In a case of determining that a notification of the completion of the system boot processing has been received within a given period of time, in other words, in a case of determining that the system boot processing has been completed normally, the server monitoring module 113 ends the processing of FIG. 15.

In a case of determining that a notification of the completion of the system boot processing has not been received within a given period of time, in other words, in a case of determining that a failure has occurred in the system boot processing, the server monitoring module 113 transfers the system recovering module 127 to the system-side server machine 101, and then activates the system recovering module 127 within the system-side server machine 101 (Step 1403).

The server monitoring module 113 determines whether or not a recovery completion notification has been received from the system recovering module 127 (Step 1404).

In a case of determining that a recovery completion notification has not been received from the system recovering module 127, the server monitoring module 113 periodically executes Step 1404 until it is determined that a recovery completion notification has been received from the system recovering module 127.

In a case of determining that a recovery completion notification has been received from the system recovering module 127, the server monitoring module 113 re-activates the system control module 102 (Step 1405), and ends the processing of FIG. 15.

FIG. 16 is a flow chart illustrating processing of the system recovering module 127 according to the embodiment of this invention.

The system recovering module 127 obtains the block location information of the fixed area 122 from the boot information storing area 128 (Step 1501). The information obtained in Step 1501 is block location information that is created when the system-side server machine 101 has booted up normally.

The system recovering module 127 determines whether or not processing has been finished for every referred-to block location (Step 1502).

In a case of determining that not all of the processing for the referred-to block locations have been finished, the system recovering module 127 obtains referred-to block location information from the referred-to block recording area 120 (Step 1503).

The system recovering module 127 determines whether or not the referred-to block location information includes information other than the block location of the fixed area 122 (Step 1504). In other words, the system recovering module 127 determines whether the failure is one that has occurred during the processing of reading the fixed area or one that has occurred during the processing of reading a file included in the system file 123. More strictly, the system recovering module 127 determines whether the failure has occurred during processing that is executed before the OS 203 is booted up or during the processing of booting up the OS 203.

In a case of determining that the referred-to block location information includes information other than the block location of the fixed area 122, in other words, in a case of determining that the failure has occurred during the processing of reading a file included in the system file 123 (failure during the processing of booting up the OS 203), the system recovering module 127 repairs the metadata 108 within the file system 107 (Step 1505).

The system recovering module 127 obtains a file that is stored in the boot information storing area 128 and that is necessary for the processing of booting up the OS 203 (Step 1506).

The system recovering module 127 uses the obtained file to recover the system file 123 (Step 1507).

A file necessary for system boot processing is recovered through Steps 1505 to 1507.

In a case of determining in Step 1502 that processing has been finished for every referred-to block location, in other words, in a case of determining that the failure has occurred during the processing of reading the fixed area 122 (a failure during processing that is executed before the OS 203 is booted up), the system recovering module 127 obtains information about the fixed area 122 that is stored in the boot information storing area 128 (Step 1508).

The system recovering module 127 uses the obtained information to recover the fixed area 122 (Step 1509), and proceeds to Step 1510.

The fixed area 122 is recovered through Steps 1508 and 1509.

The recovery processing of Steps 1505 and 1509 may be a recovery of a failure occurring site that is accomplished by restoring the obtained information.

According to this embodiment, the computer system identifies information (file) necessary for boot processing from information on the location of a block in the logical volume 121 that has been accessed in system boot processing, and saves information about the identified information (file). The computer system also saves information of the fixed area 122 that is necessary for system boot processing.

In the event of a failure in system boot processing, the computer system may thus recover only the information (file) necessary for the system boot processing, which makes a quick recovery of the system-side server machine 101 possible. Accordingly, the failure recovery processing time may be shortened greatly.

Further, storing referred-to block location information enables the computer system to determine whether the cause of a boot-up failure is a failure during the processing of reading the fixed area 122 or a failure during the processing of reading the file system 107. In other words, the computer system may determine whether the cause of a failure in system boot processing is a failure in processing that is executed before the OS 203 is booted up or a failure in the processing of booting up the OS 203. In this way, finer recovery processing may be executed while information (file) necessary for failure recovery is minimized.

The fixed area in this embodiment is a master boot record (MBR) and a boot sector. However, the fixed area is not limited thereto and may be any data that is read before the OS 203 is booted up.

The system-side server machine 101 of this embodiment may include an extensible firmware interface (EFI) instead of the BIOS 109.

In this embodiment, information necessary for processing that precedes the processing of booting up the OS 203 and for the OS boot processing is saved, but this invention is not limited thereto. For example, in the case where the computer system has a virtualization environment, the computer system may save data necessary for processing that precedes the processing of activating the hypervisor 1602 of the system-side server machine 101, data necessary for the processing of activating the hypervisor 1602, and data necessary for the processing of booting up guest OSes (system-side logical partitions 1601).

In this embodiment, only files that are necessary for system boot processing are saved, but this invention is not limited thereto. For example, the computer system may take a backup of the entire logical volume 121 while assigning identifiers with which files necessary for system boot processing are identified. The computer system uses those identifiers to obtain the files necessary for system boot processing, thus accomplishing a recovery from a failure. This also makes operations of recovery from failures other than a failure in system boot processing possible.

Any of the system-side server machine 101, the management-side server machine 111, and the storage system 116 may include components of the other two.

While the present invention has been described in detail and pictorially in the accompanying drawings, the present invention is not limited to such detail but covers various obvious modifications and equivalent arrangements, which fall within the purview of the appended claims.

What is claimed is:

1. A computer system, comprising:
a server machine;
a storage system, which is coupled to the server machine; and
a management computer for managing the server machine and the storage system,
wherein the management computer is coupled to the server machine and to the storage system,
wherein the server machine comprises:
a first processor;
a first memory, which is coupled to the first processor;
a first network interface for coupling with the management computer;
a first disk interface for coupling with the storage system; and
an input/output management module for managing input to and output from hardware of the server machine,
wherein the management computer comprises:
a second processor;
a second memory, which is coupled to the second processor;
a second network interface for coupling with the server machine; and
a second disk interface for coupling with the storage system,
wherein the storage system comprises:
at least one or more storage mediums;
a disk controller for managing the at least one or more storage mediums; and
a third disk interface for coupling with the at least one or more storage mediums,
wherein the storage system creates at least one or more logical storage areas by using a storage area of the at least one storage medium, and provides one of the logical storage areas that has been created to the server machine,
wherein the server machine has at least one or more programs running therein, for executing various types of processing,
wherein the server machine comprises at least one or more program control modules for controlling the programs,
wherein the logical storage area provided by storage system stores information about the at least one program, and
wherein the computer system further includes:
an access recording module for recording storage areas within the logical storage area provided by storage system, which are accessed in processing of booting up one of the programs, and storing information about the storage areas as storage area information;
an information identifying module for identifying boot information, which is necessary for booting up one of the programs, based on the storage area information stored in the access recording module;
a boot information storing module for storing the identified boot information;
a boot processing monitoring module for monitoring the processing of booting up the programs; and
a program recovering module for executing recovery of one of the programs in the server machine based on the boot information in a case where a failure in the processing of booting up one of the programs running on the server machine is detected.

2. The computer system according to claim 1,
wherein the input/output management module comprises a boot start notifying module for notifying start of the processing of booting up one of the programs,
wherein the program control modules comprise a boot completion notifying module for notifying completion of the processing of booting up one of the programs, and
wherein the access recording module is configured to:
start the recording of the accessed storage areas within the logical storage area provided by storage system after a notification of the start of the processing of booting up one of the programs is received from the boot start notifying module; and
stop the recording of the accessed storage areas within the logical storage area provided by storage system after a notification of the completion of the processing of booting up one of the programs is received from the boot completion notifying module.

3. The computer system according to claim 1, wherein, as the storage area information, the access recording module records locations of blocks in the logical storage area provided by storage system, the block being a minimum unit for one of reading and writing information.

4. The computer system according to claim 3,
wherein the programs include a file system for recognizing the information that is stored in at least one or more the blocks as a file,
wherein the computer system manages an association relation between the files and the locations of the blocks, and
wherein the information identifying module identifies a file, which is necessary for booting up one of the programs running on the server machine from the locations of the blocks in the logical storage area provided by storage system based on the association relation between the files and the locations of the blocks.

5. The computer system according to claim 3,
wherein the processing of booting up one of the programs includes a plurality of processing operations, and
wherein the access recording module records the locations of the blocks for each processing operation included in the processing of booting up the one of the programs.

6. The computer system according to claim 3,
wherein the logical storage area provided by storage system includes a master boot record, which is read in the processing of booting up one of the programs, at least one or more boot sectors indicating locations of the at least one or more programs to be booted up, and an operating system, which is booted up by reading one of the boot sectors,
wherein the computer system manages the locations of the blocks of the master boot record and the boot sectors,
wherein the processing of booting up the one of the programs include processing operations comprising:
first processing, which is executed before the operating system is booted up; and
second processing, which is executed in order to boot up the operating system,
wherein the information identifying module identifies information necessary for the first processing and files necessary for the second processing, and
wherein the boot information storing module stores as the boot information the information necessary for the first processing and the files necessary for the second processing.

7. The computer system according to claim 1,
wherein the boot processing monitoring module boots up the program recovering module in a case where the failure in the processing of booting up the one of the programs running on the server machine is detected, and
wherein the program recovering module restores the boot information on the logical storage area including the detected program.

8. The computer system according to claim 1, further comprising a virtualization module,
wherein the virtualization module logically partitions physical resources of the server machine to create a plurality of logical partitions, and runs the program on one of the plurality of logical partitions.

9. A failure recovery method for a computer system having: a server machine; a storage system, which is coupled to the server machine; and a management computer for managing the server machine and the storage system,
the management computer being coupled to the server machine and to the storage system,
the server machine having: a first processor; a first memory, which is coupled to the first processor; a first network interface for coupling with the management computer; a first disk interface for coupling with the storage system; and an input/output management module for managing input to and output from hardware of the server machine,
the management computer having: a second processor; a second memory, which is coupled to the second processor; a second network interface for coupling with the server machine; and a second disk interface for coupling with the storage system,
the storage system having: at least one or more storage mediums; a disk controller for managing the at least one or more storage mediums; and a third disk interface for coupling with the at least one or more storage mediums,
the storage system creating at least one or more logical storage areas by using a storage area of the at least one storage medium, and providing the one of the logical storage areas that has been created to the server machine,
the server machine having at least one or more programs running therein, for executing various types of processing,
the server machine comprising at least one or more program control modules for controlling the at least one or more programs,
the logical storage area provided by storage system storing information about the at least one program,
the failure recovery method including the steps of:
a first step of recording, by the storage system, storage areas within the logical storage area provided by storage system, which are accessed in processing of booting up one of the programs, and storing information about the storage areas as storage area information;
a second step of identifying, by the at least one or more program control modules, boot information, which is necessary for booting up the one of the programs, based on the storage area information;
a third step of sending, by the at least one or more program control modules, the identified boot information to the management computer;
a fourth step of storing, by the management computer, the boot information sent from the server machine;
a fifth step of monitoring, by the management computer, the processing of booting up the programs; and
a sixth step of executing, by the management computer, recovery of the one of the programs in the server machine based on the boot information in a case where a failure in the processing of booting up one of the programs running on the server machine is detected.

10. The failure recovery method according to claim 9,
wherein the input/output management module comprises a boot start notifying module for notifying start of the processing of booting up one of the programs,
wherein the one of the programs comprise a boot completion notifying module for notifying completion of the processing of booting up the programs, and
wherein the first step includes the step of:
starting the recording of the accessed storage areas within the logical storage area provided by storage system after a notification of the start of the processing of booting up one of the programs, by the storage system received from the boot start notifying module; and
stopping the recording of the accessed storage areas within logical storage area provided by storage system after a notification of the completion of the processing of booting up the one of the programs received from the boot completion notifying module.

11. The failure recovery method according to claim 9, wherein the first step includes the step of recording, as the storage area information, locations of blocks in the logical storage area provided by storage system, the block being a minimum unit for one of reading and writing information.

12. The failure recovery method according to claim 11,
wherein the programs include a file system for recognizing the information that is stored in at least one or more of the blocks as a file,
wherein the computer system manages an association relation between the files and the locations of the blocks, and
wherein the second step includes the step of identifying a file necessary for booting up the one of the programs running on the server machine from the locations of the blocks in the logical storage area provided by storage system based on the association relation between the files and the locations of the blocks.

13. The failure recovery method according to claim 11,
wherein the processing of booting up one of the programs includes a plurality of processing operations, and
wherein the second step includes the step of recording the locations of the blocks for each processing operation included in the processing of booting up the one of the programs.

14. The failure recovery method according to claim 11,
wherein the logical storage area provided by storage system includes a master boot record, which is read in the processing of booting up one of the programs, at least one or more boot sectors indicating locations of the at least one or more programs to be booted up, and an operating system, which is booted up by reading one of the boot sectors,
wherein the computer system manages the locations of the blocks of the master boot record and the boot sectors,
wherein the processing of booting up one of the programs include processing operations including:
first processing, which is executed before the operating system is booted up; and
second processing, which is executed in order to boot up the operating system,
wherein the second step comprises identifying information necessary for the first processing and files necessary for the second processing, and
wherein the fourth step comprises storing as the boot information the information necessary for the first processing and the files necessary for the second processing.

15. The failure recovery method according to claim 9,
wherein the fifth step includes executing the recovery of the one of the programs in a case where the failure in the processing of booting up the one of the programs running on the server machine is detected, and
wherein the sixth step includes the step of restoring the boot information, which has been stored in the fourth step, on the logical storage area including the detected program.

16. The failure recovery method according to claim 9,
wherein the computer system further includes a virtualization module, and
wherein the virtualization module logically partitions physical resources of the server machine to create a plurality of logical partitions, and runs the program on one of the plurality of logical partitions.

17. The failure recovery method according to claim 16, further including the step of recording, by the at least one or more program control modules, the storage areas within the logical storage area provided by storage system, which is accessed in the processing of booting up the program run on the one of the plurality of logical partitions, and keeping the storage area information.
